(19) United States
(12) Patent Application Publication
(10) Pub. No.: US 2022/0007438 A1
(43) Pub. Date: Jan. 6, 2022

(54) Selecting a Wireless Network Connection

(71) Applicant: Google LLC, Mountain View, CA (US)

(72) Inventors: Mukesh Agrawal, Mountain View, CA (US); Rebecca Lynn Braynard Silberstein, Sunnyvale, CA (US)

(73) Assignee: Google LLC, Mountain View, CA (US)

(21) Appl. No.: 17/311,984

(22) PCT Filed: Jan. 2, 2019
(86) PCT No.: PCT/US2019/012105

§ 371 Date: Jun. 8, 2021

(51) Int. Cl. H04W 76/10; H04B 17/318; H04W 48/18; H04W 24/08

(52) U.S. Cl. CPC H04W 76/10; H04B 17/318; H04W 84/12; H04W 24/08; H04W 48/18

(57) ABSTRACT

The present disclosure describes systems and methods directed to a user equipment (UE) selecting a network connection. The described systems and methods include the UE receiving a wireless network suggestion requesting connection of the UE to a wireless local area network (WLAN), the wireless network suggestion received from a network-suggesting entity. The UE reviews at least one of connection performance data relating to one or more previous network connections with the WLAN and/or suggestor performance data relating to one or more previous wireless network suggestions received from the network-suggesting entity. The UE then determines, based on the review, whether the connection performance data and/or the suggestor performance data satisfies a criterion. Upon determining that a criterion is satisfied, the UE establishes a wireless connection with the WLAN.

### BACKGROUND

The proliferation of wireless communications has greatly increased the number of entities, both on and off a user equipment device, that may attempt to control the wireless network connectivity of the user equipment device.

Often, a user equipment device (UE device) can only connect wirelessly to a single network at a given time (e.g., connect to a single service set identifier (SSID)). This single network connection can lead to conflicts between network-suggesting entities desiring to control the network connectivity of the UE device. For example, a conflict instance is where a first network-suggesting entity desires a first network connection, while a second network-suggesting entity desires a second (different) network connection. In such a case, the current solution is to let the “last caller win” and fulfill the most-recently received network connection call (in this example, the network connection call from the second network-suggesting entity). As a result of such a last caller win solution, the first network-suggesting entity may again request connection to the first network connection, potentially triggering a connection loop where the UE device repeatedly connects and disconnects from the two network connections in order to satisfy requests from the two network-suggesting entities, needlessly expending both power resources and network resources.

Occasionally, a UE device will be unable to connect to a wireless network connection suggested by a network-suggesting entity. In such instances, the UE device and network may needlessly expend both power resources and network resources in attempting to make such a connection.

Occasionally, a UE device will connect to a wireless network connection suggested by a network-suggesting entity, but may not end up using the network connection. In such instances, the UE device and network will have needlessly expended both power resources and network resources in making such a connection.

Occasionally, a UE device will connect to a wireless network connection (e.g., a local-only (without Internet access) wireless local area network (WLAN)) suggested by a network-suggesting entity for a limited purpose and when that limited purpose is complete the UE device may continue to use the wireless network connection, even though an Internet-capable WLAN network connection is available to the UE device. In some instances, the availability of Internet access to the device will have been needlessly interrupted. In some cases, the UE device may connect to a cellular data network in order to provide the UE device with Internet access, and the user may incur unnecessary cellular network charges (e.g., due to the unnecessary utilization of cellular data).

Occasionally, a UE device may connect to a wireless network connection (e.g., a cellular network) suggested by a network-suggesting entity for a limited purpose and when that limited purpose is complete the UE device may continue to use the wireless network connection, even though a wireless local area network connection is available to the UE device. In such instances, the user may incur unnecessary cellular network charges (e.g., due to the unnecessary utilization of cellular data). Further, the user may incur unnecessary charges even if the suggested network is a WLAN network (e.g., a user might connect to a fast WLAN network at the airport to download an important document, but the airport might also offer a free, but slower, WLAN network that is sufficient for web browsing and e-mail). In such instances, the user may incur unnecessary WLAN network charges caused by not utilizing the free WLAN network once the important document was downloaded.

### SUMMARY

This document describes techniques and apparatuses for a user equipment device (UE device) to select a wireless network connection to connect to, particularly when presented with multiple wireless network connection options. These techniques include the UE device receiving a suggested network connection from a network-suggesting entity and reviewing performance data regarding the network-suggesting entity and/or the suggested network connection to determine whether the UE device should connect to the suggested network connection.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

This specification describes techniques and apparatuses for a user equipment device to select a wireless network connection with reference to the following drawings. The same numbers are used throughout the drawings to reference like features and components:

FIG. 1 illustrates an example wireless network environment which can implement various aspects of selecting a wireless network connection in user equipment devices.

FIG. 2 illustrates an example device diagram for a user equipment device that can implement various aspects of selecting a wireless network connection in user equipment devices.

FIG. 3 illustrates an example device diagram for a base station device that can implement various aspects of selecting a wireless network connection in user equipment devices.

FIG. 4 illustrates an example device diagram for a wireless local area network access point that can implement various aspects of selecting a wireless network connection in user equipment devices.

FIG. 5 illustrates an example device diagram for another user equipment device that can implement various aspects of selecting a wireless network connection in user equipment devices.

FIG. 6 illustrates an example method of a user equipment device selecting a WLAN network connection to connect to.

FIG. 7 illustrates an example method of a user equipment device selecting a WLAN network connection to connect to.

### DETAILED DESCRIPTION

### Overview

Typically, cellular data connections are considerably more expensive for users than utilizing an accessible wireless local area network (WLAN) for data connectivity. Further, cellular data connections typically have lower-performance (e.g., reliability, latency, end-to-end throughput) than a WLAN network connection. As a result, there is a great benefit to utilizing a WLAN network for data connectivity whenever possible.

This document describes techniques and apparatuses for a user equipment device to select a wireless network connection. The described techniques and apparatuses include the user equipment device (UE device) receiving one or more network suggestions from one or more network-suggesting entities (suggestors). A reduction in the frequency of transmissions sent/received by the UE device and power savings may result from a utilization of the techniques and apparatuses described herein.

Examples of suggestors (network-suggesting entities) include one or more applications on the UE device and/or internal implementations of the UE device. A wireless network suggestion by a suggestor may request connection of the UE device to a wireless network (e.g., a wireless local area network (WLAN)) and may include a mechanism for connecting to the wireless network (e.g., credentials).

In some aspects, the described techniques and apparatus further include the UE device reviewing connection performance data (e.g., data relating to the suggested network connection, data relating to connection performance of the suggested network connection, such as a signal strength or data-rate) and/or suggestor performance data (e.g., data regarding the network-suggesting entity which made the network suggestion, data indicative of a usability and/or availability of the network-suggesting entity, such as, during a monitored period of time), determining that the connection performance data and/or the suggestor performance data satisfies one or more criteria, and if the one or more criteria are satisfied, then the UE device establishes a wireless connection with the suggested wireless network.

For example, while the user of a UE device may have configured their UE device to, when available, utilize a WLAN connection for data connectivity instead of utilizing cellular data, a network-suggesting entity may be aware of another in-range wireless network (e.g., cellular network, WLAN network, public hotspot, ad hoc network, a WiFi network provided by a cellular network provider) which provides some additional service (e.g., a connection to a wireless printer, Multimedia Broadcast Multicast Service (MBMS)) to which the UE device and/or the network-suggesting entity can utilize and the network-suggesting entity may recommend connection to the other wireless network.

In another example, the network-suggesting entity may recommend connection with a wireless network that the user of the UE device is unaware of (e.g., a WLAN network at a nearby coffee shop). In another example, the network-suggesting entity may recommend a network that the user of the UE device has access to or a network for which the user device has a subscription for (e.g., a Xfinity™ wireless (WiFi) hotspot, a Boingo™ WiFi hotspot, an iPass™ WiFi hotspot). In another example, the network-suggesting entity may recommend a wireless network that wireless carriers might be offloading traffic to (e.g., a Project Fi™ mobile virtual network, Verizon™ stadium WiFi). In another example, the network-suggesting entity may recommend a wireless network that is used to provision Internet-of-Things (IoT) devices (e.g., cameras, Chromecast™ devices). In another example, the network-suggesting entity may recommend a network that integrates with the user's service industry, profession, and/or business (e.g., hospitality, medical). In another example, the network-suggesting entity may recommend a network of a service and/or business patronized by the user.

In some aspects, the described techniques and apparatus may further include utilization of scan result predictions predicting future connectivity scan results. For example, based on received signal strength indicator (RSSI) signals received, the UE device may generate a scan result RSSI prediction which predicts future RSSI values based on previously received RSSI values and this scan result RSSI prediction may be used by the UE device to be more selective in when to perform a full wireless connectivity scan.

By using one or more of network suggestions, connection performance data, suggestor performance data, and/or scan result predictions, improvements in network utilization, network capacity, interference mitigation, power savings, or the like are provided.

This disclosure describes techniques and apparatuses for a UE device to select a wireless network connection, particularly when presented with multiple network connection options. These techniques and apparatuses enable UE devices to more-efficiently select a network connection, particularly when presented with multiple network connection options. As a result, there is a reduction in the frequency of transmissions sent/received by the UE device and power savings.

The techniques and apparatuses also increase the proportion of usage of wireless local area networks (WLAN) by a user equipment device, as opposed to cellular networks, in order to: deliver a lower-cost and higher-performance connectivity experience to users, increase the percent of time that the user spends connected to a WLAN network (vs. a cellular network), decrease the percent of cellular data that a user consumer consumes, and increase the quality (e.g., reliability, data stall rate, end-to-end throughput, latency) of the user's average network connection.

Aspects described below also include a method for a UE device to utilize in selecting a wireless network connection for connection to when presented with multiple wireless network connection options. The method, performed by a UE device, includes receiving, by at least one processor of the UE device, a wireless network suggestion requesting connection of the user equipment to a wireless network, the wireless network suggestion received from a network-suggesting entity. The method includes the UE device reviewing connection performance data relating to one or more previous network connections with the wireless network and/or suggestor performance data relating to previous wireless network suggestions received from the network-suggesting entity. In addition, the method includes the UE device determining, based on the reviewed data, that the reviewed data satisfies at least one criterion. The reviewed data may include one or more comparisons of multiple simultaneous suggestions. The method also includes the UE device establishing a wireless connection with the wireless network. The wireless network may be a wireless local area network (WLAN).

Aspects described below also include a method for a UE device to utilize in selecting a wireless network connection for connection to. The method is performed by a UE device and includes storing connection performance data relating to previous network connections with a wireless network and storing suggestor performance data relating to previous wireless network suggestions received by the user equipment. At a later time, the user equipment may receive a new wireless network suggestion requesting connection of the user equipment to the wireless network. The method may also include the UE device reviewing the connection performance data and the suggestor performance data and determining, based on review, that the connection performance data and/or the suggestor performance data satisfies a criterion. In addition, the method includes the UE device establishing a wireless connection with the wireless network. The wireless network may be a wireless local area network (WLAN).

Aspects described below also include a UE device which includes a transceiver, at least one processor configured to receive a current wireless network suggestion requesting connection of the UE device to a wireless network, and the processor and computer-readable storage media comprising instructions to implement a grading manager. The grading manager is configured to cause the UE device to measure (e.g., active measurement, passive measurement) connection performance data relating to a previous network connections with the wireless network, store the connection performance data relating to previous network connections with the wireless network, measure (e.g., active measurement, passive measurement) suggestor performance data relating to previous wireless network suggestions received by a processor of the UE device, and store the suggestor performance data relating to previous wireless network suggestions received by a processor of the UE device. The UE device then receives the current wireless network suggestion requesting connection of the UE device to the wireless network, reviews the connection performance data and the suggestor performance data, and determines, based on reviewed connection performance data and the suggestor performance data, that the connection performance data and/or the suggestor performance data satisfies a criterion. Upon determining that the criterion is satisfied, the UE device establishes, via the transceiver, a wireless connection with the wireless network. The wireless network may be a wireless local area network (WLAN).

While any number of different environments, systems, devices, and/or various configurations can implement features and concepts of the described techniques and apparatuses for selecting a network connection in UE devices, aspects of selecting a wireless network connection in UE devices are described in the context of the following example devices, methods, systems, and configurations.

### Example Environments

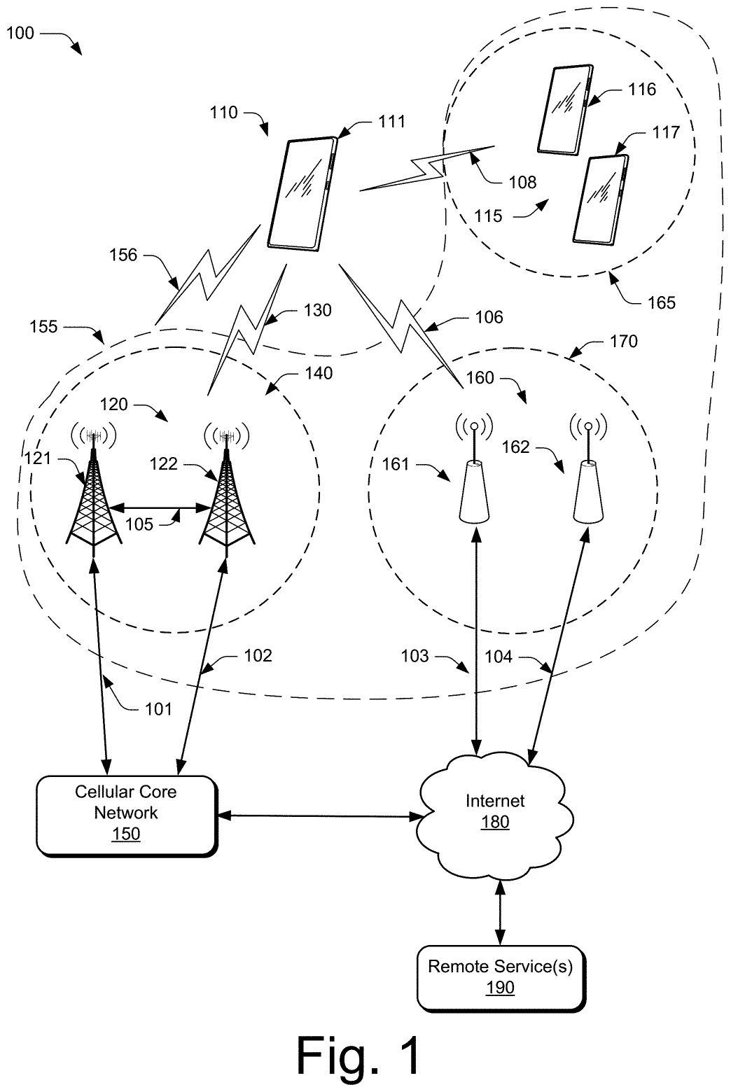

FIG. 1 illustrates an example environment 100 which may embody various aspects of a user equipment device 110 selecting a wireless network connection to connect to. In the example environment 100, a user equipment device 110 (UE device 110) may communicate with a wireless network 155 via one or more wireless communication links 156 (wireless link 156). A wireless network 155 to which a network-suggesting entity may suggest the UE device 110 connect to can include any suitable network, including, but not limited, to the Radio Access Network 140 of the base stations 120, the wireless network 170 of the wireless access points 160, the device-to-device network 165 of another UE device 115 described herein, and the like. The UE device 110 may communicate with the wireless network 155 through one or more wireless communication links 156 (wireless link 156), which may be implemented as any suitable type, or any suitable combination of types, of wireless link.

A user equipment device 110 may communicate with one or more base stations 120 through one or more wireless communication links 130 (wireless link 130), with one or more wireless network access points 160 (AP 160) through one or more wireless communication links 106 (wireless link 106), and a UE device 110 (e.g., UE device 111) can communicate with one or more other user equipment devices 115 (UE device 115) through one or more wireless communication links 108 (wireless link 108).

The UE device 110 also can connect to the Internet 180 using a connection 106 to a wireless access point 160 (AP 160), illustrated as wireless access point 161 (AP 161) and wireless access point 162 (AP 162) connecting to the Internet 180, via the network interfaces 103 and 104. The AP 160 may be located in a user's home, an office, airport, coffee shop, and so forth. Each AP 160 may be independently operated, such as in a user's home, may be part of a wireless network 170, which is illustrated as including AP 161 and 162. For example, a wireless network 170 may be an enterprise network or a public network of AP 160 operated by a wireless network operator. The wireless network operator may be the same as the operator of the RAN 140 or different than the operator of the RAN 140. AP 161 and AP 162 may be in the same wireless network 170 or may be in different wireless networks. In one aspect, the wireless access point 160 is a wireless local area network (WLAN) access point and the network 170 is a WLAN network.

The base stations 120 communicate with the UE device 110 via the wireless link 130, which may be implemented as any suitable type, or any suitable combination of types, of wireless link. The wireless link 130 can include a downlink of data and control information communicated from the base stations 120 to the UE device 110, an uplink of other data and control information communicated from the UE device 110 to the base stations 120, or both. A wireless link 130 may include one or more wireless links or bearers implemented using any suitable communication protocol or standard, or combination of communication protocols or standards, such as a Global System for Mobile Communications (GSM) protocol, a High Speed Packet Access (HSPA) protocol, an Evolved HSPA (HSPA+) protocol, a Long-Term Evolution (LTE) protocol (e.g., 4G), an LTE Advanced protocol, 3rd Generation Partnership Project Long-Term Evolution (3GPP LTE), a Fifth Generation New Radio (5G NR) protocol, a 5GS mobility management (5GMM) protocol, future advanced protocols, Institute of Electrical and Electronics Engineers (IEEE) 802.11 (Wi-Fi™), IEEE 802.16 (Worldwide Interoperability for Microwave Access (WiMax™)), IEEE 802.15 (e.g., Bluetooth™), IEEE 802.15.4 (e.g., Zigbee™), Ultra-Wideband (UWB), and so forth. Multiple wireless links 130 may be aggregated in a carrier aggregation to provide a higher data-rate for the UE device 110. Multiple wireless links 130 from multiple base stations 120 may be configured for Coordinated Multipoint (CoMP) communication with the UE device 110.

The base stations 120 are collectively a Radio Access Network 140 (RAN 140, Evolved Universal Terrestrial Radio Access Network 140, E-UTRAN 140, and 5G NR RAN 140). As illustrated in FIG. 1, the base stations 121 and 122 in the RAN 140 are connected to a cellular core network 150 (core network 150) to form a wireless operator network. The core network 150 may include a 5G core network, an Evolved Packet Core (EPC), or a combination of both. The base stations 121 and 122 connect, at 101 and 102 respectively, to the core network 150 via an NG2 interface for control-plane signaling and via an NG3 interface for user-plane data communications when connecting to 5G core network functions. The base stations 121 and 122 connect, at 101 and 102 respectively, to EPC entities via an S1 interface for control-plane signaling and user-plane data communications when connecting to EPC core network entities. In addition to connections to core network, base stations 120 may communicate with each other. The base stations 121 and 122 communicate, at 105 via an Xn interface if the base stations 120 are 5G base stations, or via an X2 interface if the base stations 120 are E-UTRA base stations.

The UE device 110 (e.g., UE device 111) can also wirelessly connect with one or more other UE device 115 (e.g., UE device 116, UE device 117) via a device-to-device wireless connection (e.g., wireless communication link 108). The other UE device 115 may represent a device-to-device network 165. In one example, the other UE device 116 is an Internet-of-Things device and the device-to-device network 165 is an ad hoc network. In another example, the other UE device 117 is a smartphone and the device-to-device network 165 is a Bluetooth™ network. In another example, the other UE device 116 is a laptop computer serving as a Wi-Fi Direct device and the device-to-device network 165 is a Wi-Fi Direct network. In another example, the other UE device 117 is a wireless printer and the device-to-device network 165 is an IEEE 802.11 network.

Although UE device 111 is illustrated as a smartphone, a UE device 110 may be implemented as any suitable computing or electronic device, such as a user equipment device, a mobile communication device, a computing device, a client device, a mobile phone, a tablet computer, a laptop computer, a communication device, an entertainment device, a gaming device, a mobile gaming console, a personal media device, a media playback device, a charging station, an Advanced Driver Assistance System (ADAS), a point-of-sale (POS) transaction system, a health monitoring device, a drone, a camera, a wearable smart-device, a navigation device, a mobile-internet device (MID), an Internet home appliance capable of wireless Internet access and browsing, an Internet-of-Things (IoT) device, a Fifth Generation New Radio user equipment, and/or other types of user devices.

In FIG. 1, the base stations 120 (e.g., base station 121, base station 122) are each illustrated as a tower of a cellular network. However, the base station 120 may represent or be implemented as another device, radio access node, wireless communication node, or other suitable piece of equipment that facilitates wireless communication (via a wireless link) between user equipment device and a communication network, such as a NodeB base station, a Next Generation Base NodeB (gNB) base station, an Enhanced NodeB (eNB) base station, an evolved NodeB (eNodeB) base station, a Global System for Mobile Communication (GSM) base station, a code-division multiple-access (CDMA) base station, a base transceiver system, a Local Access Network (LAN) router, a Wireless Local Access Network (WLAN) router, a wireless access point (WAP) in a managed (infrastructure) wireless network, a satellite, a terrestrial television broadcast tower, an access point, a peer-to-peer device, another smart phone acting as a base station, and so forth. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof.

In FIG. 1, the wireless AP 160 (e.g., AP 161, AP 162) are each illustrated as a wireless access point. However, the AP 160 may represent or be implemented as another device, radio access node, wireless communication node, or other suitable piece of equipment that facilitates wireless communication (via a wireless link) between user equipment device and a communication network, such as a Local Access Network (LAN) router, a Wireless Local Access Network (WLAN) router, a wireless access point (WAP) in a managed (infrastructure) wireless network, a WiMAX subscriber station, a WiMAX gateway device, a Wi-Fi Direct device, a satellite, a terrestrial television broadcast tower, an access point, a peer-to-peer device, a user equipment device, another smart phone acting as a base station, a user equipment device acting as a base station, a wireless ad hoc network node, and so forth.

In FIG. 1, the other UE device 115 (e.g., UE device 116, UE device 117) are illustrated as smartphones. However, the other UE device 115 may represent or be implemented as another device, radio access node, wireless communication node, or other suitable piece of equipment that facilitates wireless communication (via a wireless link) between user equipment device and a communication network, such as a Local Access Network (LAN) router, a Wireless Local Access Network (WLAN) router, a wireless access point (WAP) in a managed (infrastructure) wireless network, a WiMAX subscriber station, a WiMAX gateway device, a Wi-Fi Direct device, a satellite, a terrestrial television broadcast tower, an access point, a peer-to-peer device, a user equipment device, another smart phone acting as a base station, a user equipment device acting as a base station, a wireless ad hoc network node, and so forth.

### Example Devices

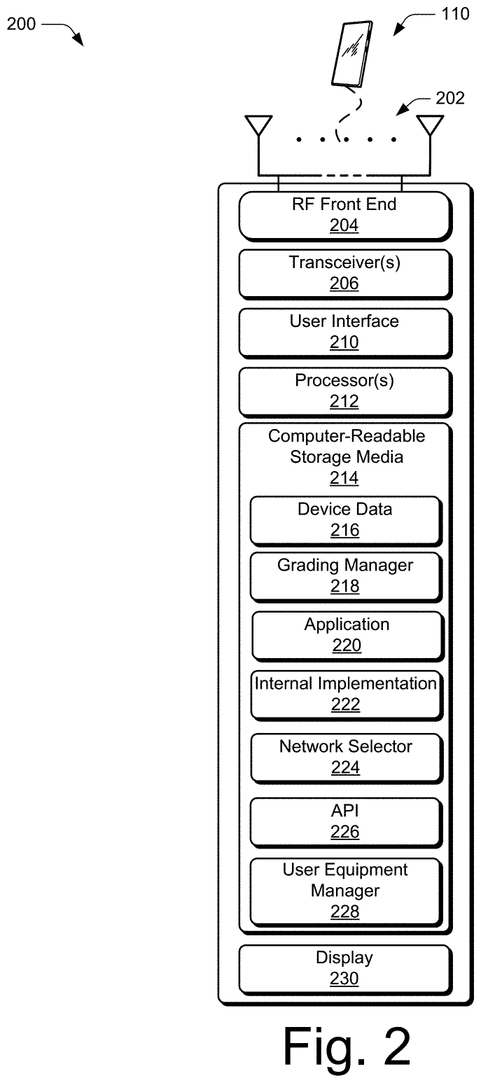

FIG. 2 illustrates an example device diagram 200 of a UE device 110. The UE device 110 may include additional functions and interfaces omitted from FIG. 2 for the sake of clarity. The UE device 110 includes antennas 202, a radio frequency front end 204 (RF front end 204), and at least one transceiver 206 for communicating with another UE device 115, wireless access points 160, and/or base stations 120. Alternately or additionally, any of the components of the UE device 110 may be implemented in whole or part as hardware logic or circuitry integrated with or separate from other components of the UE device 110.

The transceiver(s) 206 may include one or more of an LTE transceiver, a 5G NR transceiver, a WLAN transceiver configured to operate in any WLAN frequency band and using any protocols defined in the IEEE 802.11 specifications, and/or another transceiver(s). The RF front end 204 of the UE device 110 can couple or connect the transceiver(s) 206 to the antennas 202 to facilitate various types of wireless communication (e.g., for communicating with another UE device 115, for communicating with an AP 160, for communicating with base station 120). For instance, UE device 110 may utilize a connectivity scan to search for a wireless network 155 (e.g., the device-to-device wireless network 165 of another UE device 115, the wireless network 170 of an AP 160, a RAN 140 of a base station 120) to connect to. The antennas 202 of the UE device 110 may include an array of multiple antennas that are configured similar to or differently from each other. The antennas 202 and the RF front end 204 can be tuned to, and/or be tunable to, one or more frequency bands defined by wireless communication standards and implemented by the transceiver(s) 206.

The UE device 110 may further include a user interface 210 that is configured to receive inputs from a user of the UE device 110. In some instances, a user may input information that may define and/or facilitate one or more aspects of selecting a wireless network. For example, input information may include a selection input and entry of credentials, or the like. In some instances, the user interface 210 includes a graphical user interface (GUI) that receives the input information via a touch input. In other instances, the user interface 210 includes an intelligent assistant that receives the input information via an audible input.

The UE device 110 also includes processor(s) 212 and computer-readable storage media 214 (CRM 214). The processor(s) 212 may be a single core processor or a multiple core processor composed of a variety of materials, such as silicon, polysilicon, high-K dielectric, copper, and so on. The computer-readable storage media 214 described herein excludes propagating signals. The CRM 214 may include any suitable memory or storage device such as random-access memory (RAM), static RAM (SRAM), dynamic RAM (DRAM), non-volatile RAM (NVRAM), read-only memory (ROM), or Flash memory useable to store device data 216 of the UE device 110. The device data 216 includes user data, multimedia data, beamforming codebooks, applications (e.g., application 220), and/or an operating system of the UE device 110, which are executable by processor(s) 212 to enable user-plane communication, control-plane signaling, and user interaction with the UE device 110. The UE device 110 may include an operating system maintained as a computer application on the CRM 214 and executed by the processor(s) 212. Aspects and functionalities of the UE device 110 may be operated via operating system controls presented through at least one application programming interface 226 (API 226). The CRM 214 may further include an internal implementation 222 (e.g., with the operating system of the UE device, open network notification systems which indicate to a user that an open network (e.g., no password needed) is available (e.g., Open Network Available (ONA), Open Network Notifier (ONN)), settings of the UE device (e.g., Settings), saved network evaluator systems (e.g., SavedNetworkEvaluator)) of the UE device 110.

The CRM 214 may also include a user equipment manager 228. Alternately or additionally, the user equipment manager 228 may be implemented in whole or part as hardware logic or circuitry integrated with or separate from other components of the UE device 110. In at least some aspects, the user equipment manager 228 configures the RF front end 204 and/or the transceiver(s) 206 to implement the techniques for selecting a wireless network connection to connect to described herein.

The CRM 214 may also include executable code of a grading manager 218 (e.g., a grading manager application 218, WiFi scorer). Alternately or additionally, the grading manager 218 may be implemented in whole or part as hardware logic or circuitry integrated with or separate from other components of the UE device 110. In at least some aspects, the UE device 110, via the processor(s) 212 executing the code of the grading manager 218, performs operations associated with selecting a wireless network connection to connect to in accordance with aspects described herein.

The grading manager 218 of the UE device 110 may measure (e.g., active measurement, passive measurement) and collect connection performance data relating to a wireless network 155. The connection performance data may be collected when a connection (via a wireless link 156) to the wireless network 155 is active and/or at disconnect. In some cases, the network-suggesting entity (e.g., an application 220 on the UE device 110) may provide connection performance data to the grading manager 218. For example, an application 220 may have access to information that the UE device 110 is not measuring or is not able to measure. For instance, such information may include the past performance of a wireless network 155 unknown to the UE device 110 and/or the existence of a wireless network 155, access to which the user has already paid for.

To preserve user privacy, give timely information, and to not require a remote connection, the grading manager 218 of the UE device 110 stores connection performance data as device data 216 in the CRM 214. The connection performance data may include data such as connection data (e.g., received signal strength indicator (RSSI) signals, data-rate information (bandwidth information), latency information, end-to-end throughput, connection duration information, average connection length, signal quality information), network identity information (e.g., basic service set identifier (BSSID) limits in size information, recently utilized wireless communication channels), and other information (e.g., data relating to the disconnect, data relating to the loss of connectivity, data relating to the reason for the disconnect (such as data in the form of a corresponding disconnect parameter indicating by its parameter value one of several predefined reasons for the disconnect), data relating to the reason for the loss of connectivity (such as data in the form of a corresponding connect parameter indicating by its parameter value one of several predefined reasons for the loss of connectivity), data relating to whether the disconnect (disconnection) was expected or unexpected (such as data in the form of a corresponding expectation parameter indicating by its parameter value whether the disconnect (disconnection) was expected or unexpected), wireless network connection information (e.g., service set identifier (S SID) information, authentication information), information regarding wireless connection availability (e.g., when the wireless connection can be used, when wireless access is no longer authorized), internet protocol (IP) addresses, domain name system (DNS) servers utilized, information regarding a UE device system).

The grading manager 218 of the UE device 110 may utilize the connection performance data to populate (e.g., generate, update) a network report (e.g., a Report Card) for the wireless network 155. A network report may include previous connection performance data regarding the wireless network 155. The UE device 110 may receive connection performance data UE device 110 as connectivity scan results of connectivity scans performed by the UE device 110. Based on additional connectivity scans performed, the grading manager 218 may update the network report for the wireless network 155. To preserve user privacy, give timely information, and to not require a remote connection, the grading manager 218 stores network reports as device data 216 in the CRM 214.

A network report for a wireless network 155 may be used by a network selector 224 when performing operations associated with selecting a network connection to connect to in accordance with aspects described herein. A network report for a wireless network 155 may be used by the grading manager 218 to tune the frequency of network scoring for that wireless network, thereby allowing the UE device 110 to adapt control and scanning to the wireless network 155.

In some aspects, the UE device 110 may adjust the frequency and timing of when connectivity scans are requested by utilizing network quality predictions along with the historical connection performance data from a network report. For example, instead of checking beacon received signal strength indicator (beacon RSSI) values at a set interval (e.g., three (3) seconds), the connection performance data in a network report can be utilized by the grading manager 218 to set a RSSI threshold. Upon the UE device 110 detecting a RSSI breach event (e.g., when a measured RSSI score predicts the occurrence of a disconnect), the grading manager 218 of the UE device 110 may trigger a connectivity scan (or a series of connectivity scans) to look for alternative wireless networks 155 to connect to. In another example, upon the UE device 110 detecting a change in network suggestions received from network-suggesting entities (e.g., a new network suggestion is received which suggests connection to a wireless network which is more reliable than the currently connected wireless network) the grading manager 218 of the UE device 110 may trigger a connectivity scan (or a series of connectivity scans) to look for alternative wireless networks 155 to connect to.

The UE device 110 may perform one or more connectivity scans (e.g., a WLAN connectivity scan) to discover available wireless networks (e.g., WLAN access points) which may be connected to and to collect information regarding the available wireless networks. Through use of the described techniques, the UE device 110 can reduce the number of unnecessary connectivity scans by being more selective on when to perform a connectivity scan. For instance, by utilizing network scoring signals and scan result RSSI predictions, the grading manager 218 can be more selective regarding when to perform a full connectivity scan. Through use of the described techniques, the UE device 110 can further determine the types of connectivity scanning that need to be performed and which networks to explicitly probe for (e.g., using a Preferred Network Offload (PNO) list), thereby conserving battery power.

In some cases, the UE device 110 may further utilize a combination of connection performance data and network quality predictions from a network report to modify a list of preferred networks (e.g., a Preferred Network Offload (PNO) list) to further reduce the time spent looking for wireless networks 155, thereby conserving battery power. To preserve user privacy, give timely information, and to not require a remote connection, the UE device 110 stores the Preferred Network Offload list as device data 216 in the CRM 214.

Information from connectivity scan results may be utilized by the UE device 110 to make decisions regarding whether to connect to the wireless network and which wireless network to connect to. In some cases, a grading manager 218 may use the results of a connectivity scan to generate a scan result prediction predicting future scan results. For instance, the grading manager 218 may use RSSI results from a connectivity scan to generate a scan result RSSI prediction which predicts future RSSI values based on previously received RSSI values. To preserve user privacy, give timely information, and to not require a remote connection, the grading manager 218 stores scan result predictions as device data 216 in the CRM 214.

The CRM 214 may also include executable code of a network selector 224 (e.g., a network selector application 224). Alternately or additionally, the network selector 224 may be implemented in whole or part as hardware logic or circuitry integrated with or separate from other components of the UE device 110. In at least some aspects, the UE device 110, via the processor(s) 212 executing the code of the network selector 224, performs operations associated with selecting a wireless network connection to connect to in accordance with aspects described herein. The network selector 224 may utilize the connection performance data in one or more network reports during a wireless network selection process to determine whether to connect to a wireless network and to determine which wireless network of a plurality of wireless networks to connect to. Through the use of such network reports, a UE device 110 can adapt control and wireless network scanning to a particular wireless network.

In some cases, the network selector 224 is configured to utilize scan result predictions generated by the grading manager 218. For example, the network selector 224 may use the scan result predictions during the network selection process to determine that the wireless network is a temporary network. A temporary network may be a network that is only temporarily available (e.g., due to movement of the access point, movement of the UE device). For example, a scan result prediction may be based on the network selector 224 of the UE device 110 observing that received signal strength indicator (RSSI) signals from a wireless network 155 are gradually varying, namely getting stronger (or weaker). Based on the received RSSI signals, the grading manager 218 of the UE device 110 may predict that the wireless network 155 is a temporary network, such as a transportation vehicle (e.g., a bus, a train) with a 5G New Radio mobile integrated access and backhaul node providing wireless connections to user equipment devices on the vehicle where the vehicle is moving along a route adjacent to the location of the user equipment device. Based on this prediction, the UE device 110 may decide to not connect to the wireless network. By utilizing scan result predictions during the network selection process, the UE device 110 does not need to detect motion (e.g., utilizing a motion sensor, utilizing a position sensor, utilizing an environmental sensor, utilizing a global positioning system (GPS) sensor, utilizing a geomagnetic field sensor) to determine that the detected wireless network 155 is a temporary network.

As described above, the RF front end 204 of the UE device 110 can couple or connect the transceiver(s) 206 to the antennas 202 to facilitate various types of wireless communication, including utilizing a connectivity scan to search for a wireless network 155 (e.g., the device-to-device wireless network 165 of another UE device 115, the wireless network 170 of an AP 160, a RAN 140 of a base station 120) to connect to.

In some prior implementations, an application on the user equipment device could utilize the API service of the user equipment device to control aspects and functionalities of the user equipment device. For instance, an application could make low-level network save/enable/connect calls to the API to request connection to a wireless network.

In some aspects, the API 226 may not include a low-level network save/enable/connect function call, and instead the API 226 may permit a network-suggesting entity to make a network suggestion which suggests one or more wireless networks 155 for the UE device 110 to connect to. Alternatively, the low-level network save/enable/connect function call may be modified to permit a network-suggesting entity to make a network suggestion which suggests one or more wireless networks 155 for the UE device 110 to connect to.

In some cases, the network-suggesting entity is an internal implementation 222 (e.g., the operating system of the UE device, open network notification systems (e.g., ONA, ONN), settings of the UE device (e.g., Settings), saved network evaluator systems (e.g., SavedNetworkEvaluator)) of the UE device 110. In some cases, the network-suggesting entity is an application 220 on the UE device 110. Through use of such network suggestions, applications 220 may shift the burden of discovering wireless networks 155 to the system of the UE device 110. By so shifting the burden, the application 220 does not need to issue and/or process scan results. Additionally, by so shifting the burden, by not needing to run the application code, processor cycles on the UE device 110 can be reduced and memory pressure can be reduced. Reducing processor cycles and memory pressure on the UE device 110 serves to save power and improve latency for other tasks in the system. Further, the applications 220 that do not need to issue and/or process scan results can be run with fewer permissions, thereby improving user privacy.

The suggestor performance data may include at least one of: information regarding a frequency of successful previous connection to the wireless network, and/or information regarding previous use of the wireless network after successful connection. The grading manager 218 of the UE device 110 may grade the success of each network-suggesting entity (suggestor) by compiling performance data (suggestor performance data) regarding the performance of the network suggested. To preserve user privacy, give timely information, and to not require a remote connection, the suggestor performance data is saved as device data 216 to the CRM 214. In some cases, the suggestor performance data includes information regarding the frequency of successful previous connection to wireless networks suggested by the network-suggesting entity and/or information regarding previous use of the wireless networks suggested by the network-suggesting entity after successful connection (e.g., whether the network-suggesting entity and/or the UE device 110 utilized the network connection after the wireless network connection was made). In some cases, suggestor performance data that does not include personally identifiable information may be shared with a merchant (e.g., the Google Play™ store) to help the merchant rate the network-suggesting entity applications for the benefit of the merchant's customers and/or to inform users on reliability and quality.

The UE device 110 may use a network suggestion made by a network-suggesting entity in selecting a wireless network connection to connect to. In some cases, the UE device 110 may use a network suggestion along with scan result predictions and/or user actions (e.g., user preferences, network suggestions provided by the user, networks selected by the user) in selecting a wireless network connection to connect to. By utilizing such network suggestions as part of a network selection procedure, the UE device 110 reduces the amount of time spent and connectivity scans utilized looking for networks 155 to connect to, thereby conserving battery power and network resources.

In some cases, the UE device 110 may use a network suggestion to modify and/or maintain a list of preferred networks (e.g., a Preferred Network Offload (PNO) list). Through improved use of such a list of preferred networks, the UE device 110 reduces the amount of time spent and connectivity scans utilized looking for networks 155 to connect to, thereby conserving battery power and network resources.

A network suggestion may have a service life (e.g., use for n times, use before/during/after for a predetermined time, persistent use). In some cases, the service life may be indicative of a single (one-time) use. In some cases, the service life may be indicative of a use for a predetermined period of time (e.g., for one month). In some cases, the service life may be persistent (e.g., on-going until the application indicates otherwise, on-going until the UE device 110 decides otherwise). For instance, if a network suggestion received from an application suggests connection to a particular network any time that network is in range, then the UE device 110 could consider connection to that network any time the network is in range (e.g., the network SSID is found in connectivity scan results), regardless of whether or not the application is currently running on the UE device 110. In some cases, whether to end the persistent service life of the suggestion may be re-evaluated automatically (e.g., when the current network disconnects).

Differing network suggestors may have different terms of service, pricing, and/or performance levels with respect to the wireless networks 155 to which they suggest connection. By grading network suggestors in network reports on outcome and performance, information usable by the network selector 224 to determine which network suggestors of multiple network suggestors offer viable and high-performing network suggestions can be provided.

Through such network report grading, even though multiple applications 220 may have suggested the same wireless network 155, the network selector 224 may be able to select the network suggestion offering the best outcome and performance. For example, a first application might suggest a connection to wireless network 170 via access point 161 utilizing a first subscription, and a second application might suggest a connection to wireless network 170 via access point 161 utilizing a second subscription. Through reviewing and comparing connection performance data, the network selector 224 may determine that wireless network connections suggested by the first application are more viable/higher performing than network suggestions by the second application. In such a situation, the network selector 224 may select the wireless network connection suggested by the first application to connect to.

The UE device 110 also includes a display 230 for displaying and/or providing information to a user. For example, through the display 230, the UE device 110 may provide the user with information regarding network suggestion outcomes (e.g., historical data, performance data, outcome data). Further, through the display 230, the UE device 110 may provide the user with information regarding the grades assigned to the suggestors and/or networks, thereby giving the user more awareness about the operating state of the UE device 110 and alerting the user of any odd or unexpected behaviors. Based on such information, a user may chose to disable one or more network-suggesting entities.

The absence of network suggestions received from a suggestor may also be utilized to influence and optimize connectivity scanning. For example, if no networks are available and no applications 220 are requesting access to a wireless network, then the UE device 110 may reduce the frequency of wireless connectivity scans. The absence of network suggestions received from a suggestor may also be utilized to influence and optimize wireless power states. For example, if no wireless networks are available and no applications 220 are requesting access to a wireless network, then the UE device 110 may transition to a lower power state.

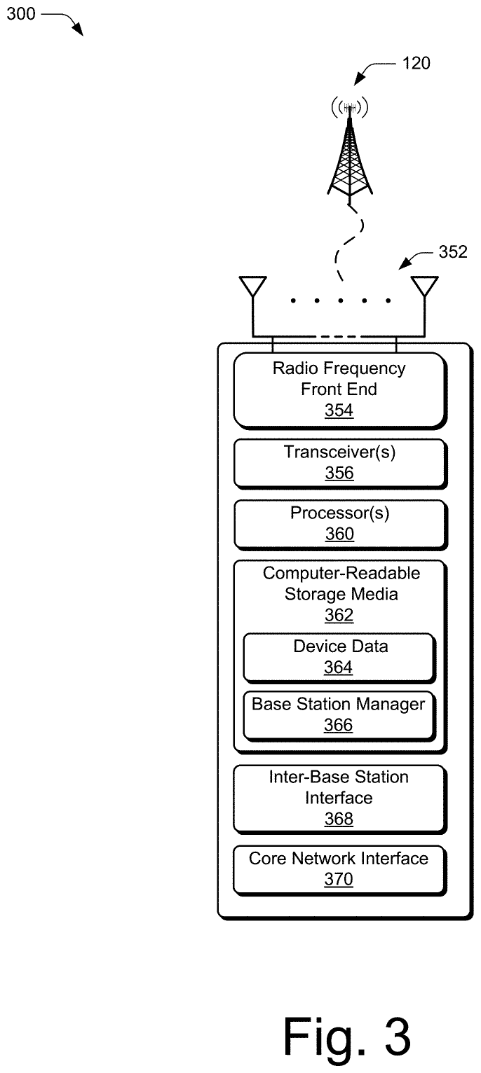

FIG. 3 illustrates an example device diagram 300 of the base stations 120. The base stations 120 may include additional functions and interfaces omitted from FIG. 3 for the sake of clarity. The device diagram for the base stations 120, shown in FIG. 3, includes a single network node (e.g., a gNode B). The functionality of the base stations 120 may be distributed across multiple network nodes or devices and may be distributed in any fashion suitable to perform the functions described herein. The base stations 120 include antennas 352, a radio frequency front end 354 (RF front end 354), and one or more transceivers 356 for communicating with the UE device 110. The RF front end 354 of the base stations 120 can couple or connect the transceiver(s) 356 to the antennas 352 to facilitate various types of wireless communication. The antennas 352 of the base stations 120 may include an array of multiple antennas that are configured similar to or differently from each other. The antennas 352 and the RF front end 354 can be tuned to, and/or be tunable to, one or more frequency band defined by communication standards and implemented by the transceiver(s) 356.

The base stations 120 also include processor(s) 360 and computer-readable storage media 362 (CRM 362). The processor(s) 360 may be a single core processor or a multiple core processor composed of a variety of materials, such as silicon, polysilicon, high-K dielectric, copper, and so on. CRM 362 may include any suitable memory or storage device such as random-access memory (RAM), static RAM (SRAM), dynamic RAM (DRAM), non-volatile RAM (NVRAM), read-only memory (ROM), or Flash memory useable to store device data 364 of the base stations 120. The device data 364 includes network scheduling data, radio resource management data, beamforming codebooks, applications, and/or an operating system of the base stations 120, which are executable by processor(s) 360 to enable communication with the UE device 110. Alternately or additionally, any of the components of the base stations 120 may be implemented in whole or part as hardware logic or circuitry integrated with or separate from other components of the base station 120.

CRM 362 also includes a base station manager 366. Alternately or additionally, the base station manager 366 may be implemented in whole or part as hardware logic or circuitry integrated with or separate from other components of the base stations 120. In at least some aspects, the base station manager 366 configures the transceivers 356 for communication with the UE device 110, as well as communication with a core network. The base stations 120 include an inter-base station interface 368, such as an Xn and/or X2 interface, which the base station manager 366 configures to exchange user-plane and control-plane data between another base station 120, and to manage the communication of the base stations 120 with the UE device 110. The base stations 120 include a core network interface 370 that the base station manager 366 configures to exchange user-plane and control-plane data with core network functions and entities. This core network interface 370 may include interfaces such as the NG2 interface 101 and the NG3 interface 102, as described previously with respect to FIG. 1.

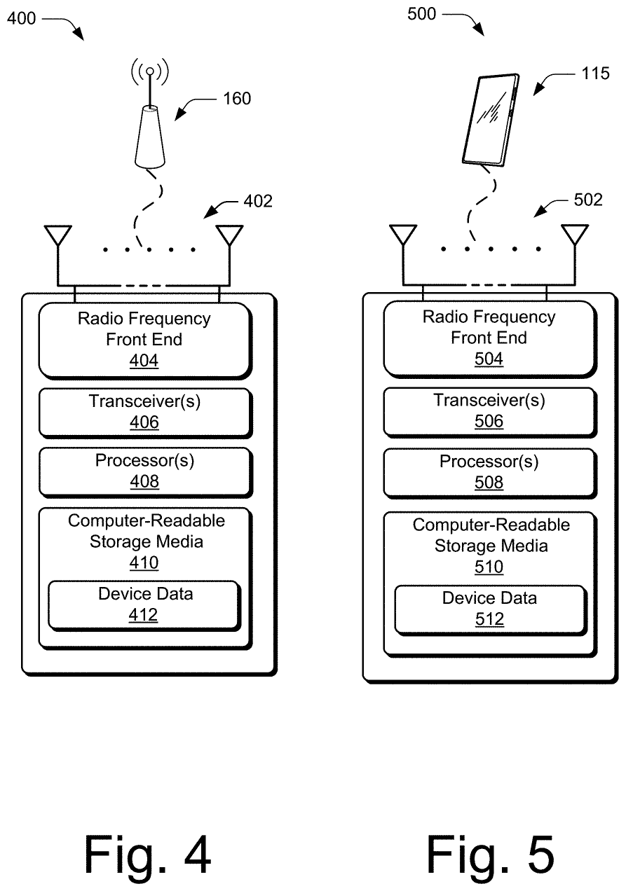

FIG. 4 illustrates an example device diagram 400 of the access points 160 (AP 160). The AP 160 may include additional functions and interfaces that are omitted from FIG. 4 for the sake of clarity. The AP 160 includes antennas 402, a radio frequency front end 404 (RF front end 404), and one or more transceivers 406 that are configured for WLAN communication with the UE device 110. The RF front end 404 can couple or connect the transceiver(s) 406 to the antennas 402 to facilitate various types of wireless communication. The antennas 402 of the AP 160 may include an array of multiple antennas that are configured similarly to or differently from each other. The antennas 402 and the RF front end 404 can be tuned to, and/or be tunable to, one or more frequency bands defined by the IEEE 802.11 communication standards and implemented by the transceiver(s) 406.

The AP 160 also includes processor(s) 408 and computer-readable storage media 410 (CRM 410). The processor(s) 408 may be a single core processor or a multiple core processor composed of a variety of materials, such as silicon, polysilicon, high-K dielectric, copper, and so on. CRM 410 may include any suitable memory or storage device such as random-access memory (RAM), static RAM (SRAM), dynamic RAM (DRAM), non-volatile RAM (NVRAM), read-only memory (ROM), or Flash memory useful to store device data 412 of the AP 160. The device data 412 includes network scheduling data, radio resource management data, applications, and/or an operating system of the AP 160, which are executable by processor(s) 408 to enable communication with the UE device 110. Alternately or additionally, any of the components of the AP 160 may be implemented in whole or part as hardware logic or circuitry integrated with or separate from other components of the AP 160.

FIG. 5 illustrates an example device diagram 500 of another user equipment device 115 (UE device 115). The UE device 115 may include additional functions and interfaces that are omitted from FIG. 5 for the sake of clarity. The UE device 115 includes antennas 502, a radio frequency front end 504 (RF front end 504), one or more transceivers 506 that are configured for communication with the UE device 110. The RF front end 504 can couple or connect the transceiver(s) 506 to the antennas 502 to facilitate various types of wireless communication. The antennas 502 of the UE device 115 may include an array of multiple antennas that are configured similarly to or differently from each other. The antennas 502 and the RF front end 504 can be tuned to, and/or be tunable to, one or more frequency bands defined by any wireless communication standard and implemented by the transceiver(s) 506.

The UE device 115 also includes processor(s) 508 and computer-readable storage media 510 (CRM 510). The processor(s) 508 may be a single core processor or a multiple core processor composed of a variety of materials, such as silicon, polysilicon, high-K dielectric, copper, and so on. CRM 510 may include any suitable memory or storage device such as random-access memory (RAM), static RAM (SRAM), dynamic RAM (DRAM), non-volatile RAM (NVRAM), read-only memory (ROM), or Flash memory useful to store device data 512 of the UE device 115. The device data 512 includes network scheduling data, radio resource management data, applications, and/or an operating system of the UE device 115, which are executable by processor(s) 508 to enable communication with the UE device 110. Alternately or additionally, any of the components of the UE device 115 may be implemented in whole or part as hardware logic or circuitry integrated with or separate from other components of the UE device 115.

### Systems

In some aspects, the UE device 110 includes at least one transceiver 206, at least one processor 212, and computer-readable storage media 214 (CRM 214). The processor 212 is configured to receive a network suggestion from a network-suggesting entity. In some cases, the network-suggesting entity is an application 220 on the CRM 214. In some aspects, the network-suggesting entity is an internal implementation 222 of the UE device 110.

In some aspects, the network suggestion requests connection of the UE device to a wireless network 155. The wireless network 155 may be a WLAN network 170 associated with one or more WLAN access points 160. The wireless network 155 may be a Radio Access Network 140 (RAN 140) associated with one or more base stations 120. The wireless network 155 may be a device-to-device network 165 associated with another UE device 115.

In some aspects, the processor(s) and computer-readable storage media together comprise instructions to implement a grading manager 218 (e.g., grading manager application 218). The grading manager 218 may be configured to cause the UE device 110 to store information relating to the wireless network 155, for instance as device data 216 stored in the CRM 214. In some aspects, the information related to the wireless network 155 is connection performance data relating to one or more previous network connections with the wireless network 155. In some cases, the information is connection performance data relating to one or more previous network connections with the wireless network 155 by the UE device 110.

In some aspects, the grading manager 218 may be configured to cause the UE device 110 to store information relating to the network-suggesting entity, for instance as device data 216 stored in the CRM 214. The information may include suggestor performance data relating to the performance of one or more previous suggestions received from the network-suggesting entity (suggestor). The information may include network suggestion performance data relating to one or more previous suggestions received from the suggestor by at least one processor of the UE device 110.

In some aspects, the grading manager 218 may be configured to receive from a network-suggesting entity a network suggestion requesting connection of the UE device 110 to a wireless network. In response to the grading manager 218 receiving the network suggestion, the UE device 110 may be configured to review connection performance data and/or suggestor performance data to determine if the connection performance data and/or the suggestor performance data satisfies one or more criteria. The review and determination regarding whether the suggestor performance data satisfies at least one criterion may include a comparison of the suggestor performance data with suggestor performance data for other network-suggesting entities. The review and determination regarding whether the suggestor performance data satisfies at least one criterion may include a comparison of the suggestor performance data with suggestor performance data for other network-suggesting entities and additional information regarding the network-suggesting entity and/or other network suggestions made by the network-suggesting entity. Upon the UE device 110 determining that the connection performance data and/or the suggestor performance data satisfies at least one criterion, the UE device 110 may initiate and establish, via the transceiver(s) 206, a wireless connection with the wireless network 155.

In some aspects, the connection performance data may include received signal strength indicator (RSSI) signals and the criterion may be a RSSI threshold (e.g., an average RSSI) detected by the grading manager 218. The connection performance data may include data-rate information and the criterion may be a data-rate threshold (e.g., an average data-rate) of a signal that is detected by the grading manager 218. The connection performance data may include latency information, and the criterion may be a latency threshold detected by the grading manager. The connection performance data may include end-to-end throughput, and the criterion may be a throughput threshold detected by the grading manager. The suggestor performance data may include at least one of information regarding a frequency of successful previous connection to the wireless network and information regarding previous use of the wireless network after successful connection, and the criterion may be a threshold of successful connections and/or a threshold of use of successful connections by the network-suggesting entity.

Additional information may be utilized as part of the determination of whether the connection performance data and/or the suggestor performance data satisfies a criterion. For example, user input received regarding the user preferences may be utilized as part of the determination of whether the connection performance data and/or the suggestor performance data satisfies a criterion. In another example, data relating to a status of the UE device 110 (e.g., a battery level) may be utilized as part of the data reviewed as part of the determination of whether the connection performance data and/or the suggestor performance data satisfies a criterion.

In some aspects, the network selector 224 of the UE device 110 reviews the connection performance data and/or suggestor performance data and determines if the connection performance data and/or the suggestor performance data satisfies a criterion. The grading manager 218 may be configured to cause the UE device 110 to initiate and establish, via the transceiver(s) 206, a wireless connection with the wireless network 155 upon the grading manager 218 determining that the connection performance data and/or the suggestor performance data satisfies a criterion.

The UE device 110 may include a user interface 210 configured to receive user input from a user of the UE device 110 regarding a wireless network 155. For instance, the user input could be a user-defined network suggestion, such as a selection input and entry of credentials on a user interface screen. In some cases, the grading manager 218 is configured to consider the user input in determining whether the connection performance data and/or the suggestor performance data satisfies the criterion.

In some aspects, the processor(s) 212 and computer-readable storage media 214 may comprise instructions to implement an application 220. The processor(s) 212 and CRM 214 may receive the network suggestion from the application 220. The application 220 may utilize the established network connection after the UE device 110 initiates the wireless connection.

In connecting to the wireless network 155, if authentication information (e.g., authorization data, log-in data) is needed from the application 220 to establish the connection with the wireless network 155, the system may trigger a call back to the application 220 requesting such authentication data. In connecting to the wireless network 155, if authorization information (e.g., authorization data, log-in data) is needed from the user to establish the connection with the wireless network 155, the system may request such authentication data from the user.

In some aspects, the network suggestion suggests connection with one or more of a Radio Access Network 140 of a base station 120, a wireless network 170 of a wireless access point 160, or a device-to-device network 165 of another UE device 115. In some aspects, a network suggestion may be made by an internal implementation (e.g., the operating system of the UE device, open network notification systems (e.g., ONA, ONN), settings of the UE device (e.g., Settings), saved network evaluator systems (e.g., SavedNetworkEvaluator) of the UE device 110.

In some aspects, UE device 110 is connected to AP 161 and receives a network suggestion from an application 220 requesting connection to base station 122. The UE device 110 reviews connection performance data relating to one or more previous network connections with base station 122 and/or suggestor performance data relating to one or more previous network suggestions received from the application 220. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with base station 122.

In some aspects, UE device 110 is connected to AP 161 and receives a network suggestion from an application 220 requesting connection to AP 162. The UE device 110 reviews connection performance data relating to one or more previous network connections with AP 162 and/or suggestor performance data relating to one or more previous network suggestions received from the application 220. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with AP 162.

In some aspects, UE device 110 is connected to a wireless network (WLAN) AP 161 and receives a network suggestion from an application 220 requesting connection to another WLAN AP 162. The UE device 110 reviews connection performance data relating to one or more previous network connections with WLAN AP 162 and/or suggestor performance data relating to one or more previous network suggestions received from the application 220. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with WLAN AP 162.

In some aspects, UE device 110 is connected to WLAN AP 161 and receives a network suggestion from an application 220 requesting connection to WLAN AP 162, where WLAN AP 162 is in a different WLAN network than WLAN AP 161. The UE device 110 reviews connection performance data relating to one or more previous network connections with AP 162 and/or suggestor performance data relating to one or more previous network suggestions received from the application 220. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with AP 162.

In some aspects, UE device 110 receives a first network suggestion from a first application requesting connection to a first WLAN network and a second network suggestion from a second application requesting connection to a second WLAN network. The UE device 110 reviews connection performance data relating to one or more previous network connections with the first WLAN network and the second WLAN network. The UE device 110 reviews suggestor performance data relating to one or more previous network suggestions received from the first application and from the second application. The UE device 110 determines, based on the information reviewed, which connection performance data and/or the suggestor performance data satisfies a criterion. Upon determining that the connection performance data and/or the suggestor performance data satisfies a criterion, the UE device 110 establishes a wireless connection with the first WLAN network.

In some aspects, UE device 110 receives a first network suggestion from a first application requesting connection to a first WLAN network and a second network suggestion from a second application requesting connection to a second WLAN network. The UE device 110 reviews connection performance data relating to one or more previous network connections with the first WLAN network and the second WLAN network. The UE device 110 reviews suggestor performance data relating to one or more previous network suggestions received from the first application and from the second application. The UE device 110 determines, based on the information reviewed, which connection performance data and/or the suggestor performance data satisfies a criterion. Upon determining that the connection performance data and/or the suggestor performance data satisfies a criterion, the UE device 110 establishes a wireless connection with the second WLAN network.

In some aspects, UE device 110 is connected to AP 161 and receives a network suggestion from an application 220 requesting connection to the device-to-device network 165 of UE device 116. The UE device 110 reviews connection performance data relating to one or more previous network connections with the device-to-device network 165 of UE device 116 and/or suggestor performance data relating to one or more previous network suggestions received from the application 220. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with device-to-device network 165 of UE device 116.

In some aspects, UE device 110 is connected to AP 161 and receives a network suggestion from an internal implementation 222 requesting connection to base station 122. The UE device 110 reviews connection performance data relating to one or more previous network connections with base station 122 and/or suggestor performance data relating to one or more previous network suggestions received from the internal implementation 222. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with base station 122.

In some aspects, UE device 110 is connected to AP 161 and receives a network suggestion from an internal implementation 222 requesting connection to AP 162. The UE device 110 reviews connection performance data relating to one or more previous network connections with AP 162 and/or suggestor performance data relating to one or more previous network suggestions received from the internal implementation 222. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with AP 162.

In some aspects, UE device 110 is connected to AP 161 and receives a network suggestion from an internal implementation 222 requesting connection to the device-to-device network 165 of UE device 116. The UE device 110 reviews connection performance data relating to one or more previous network connections with the device-to-device network 165 of UE device 116 and/or suggestor performance data relating to one or more previous network suggestions received from the internal implementation 222. The UE device 110 determines, based on the information reviewed, that the connection performance data and/or the suggestor performance data satisfies a criterion. Upon determining that the connection performance data and/or the suggestor performance data satisfies a criterion, the UE device 110 establishes a wireless connection with device-to-device network 165 of UE device 116.

Further to the descriptions above, a user may be provided with controls allowing the user to make an election as to both if and when systems, programs, and/or features described herein may enable collection of user information (e.g., received signal strength indicator (RSSI) signals, connection duration information, average connection length, signal quality information, network identity information, network basic service set identifier (BSSID) information, recently utilized wireless communication channels, a user's preferences, a user's current location) and if the user is sent content and/or communications from a server. In addition, certain data may be treated in one or more ways before it is stored or used, so that personally identifiable information is removed. For example, a user's identity may be treated so that no personally identifiable information can be determined for the user. For example, a user's geographic location may be generalized where location information is obtained (such as to a city, ZIP code, or state level), so that a particular location of a user cannot be determined. Thus, the user may have control over what information is collected about the user, how that information is used, and what information is provided to the user.

### Example Methods

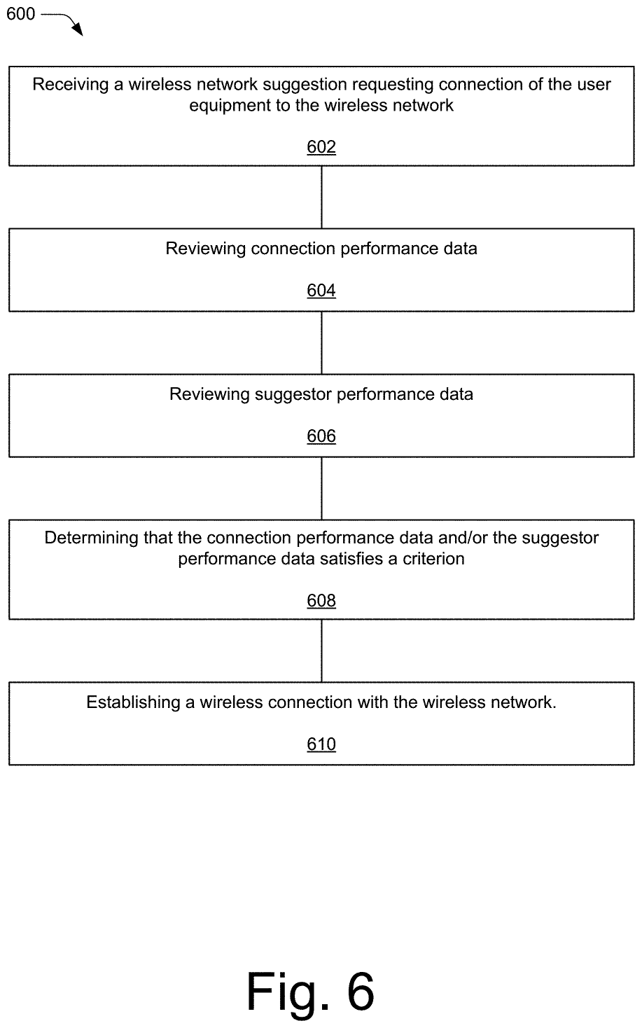

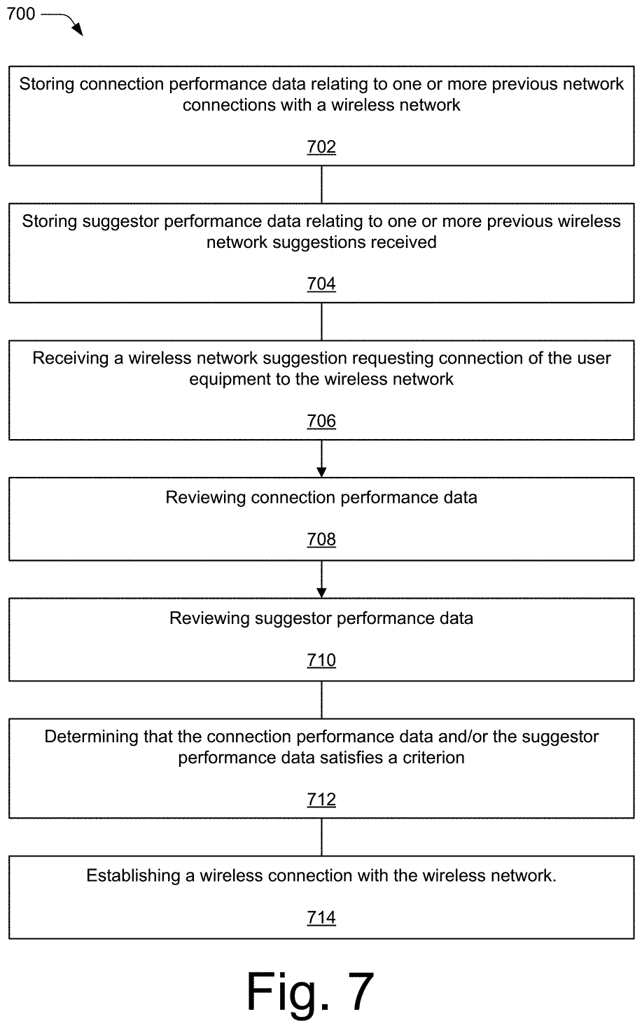

Example methods 600 and 700 are described with reference to FIGS. 6 and 7, respectively, in accordance with one or more aspects of a user equipment device selecting a wireless network connection to connect to. FIGS. 6 and 7 depict example methods 600 and 700 for a user equipment device to select a wireless network connection to connect to. Methods 600 and 700 illustrate sets of operations (or acts) performed in, but not necessarily limited to, the order or combinations in which the operations are shown herein. Further, any of one or more of the operations may be repeated, combined, reorganized, skipped, or linked to provide a wide array of additional and/or alternate methods. In portions of the following discussion, reference may be made to example wireless network environment 100 of FIG. 1, example device diagrams 200, 300, 400, and 500 of FIGS. 2, 3, 4, and 5, and entities detailed in FIG. 1, reference to which is made for example only. The techniques and apparatuses described in this specification are not limited to performance by one entity or multiple entities operating on one device.

The UE device 110 in the example methods 600, and 700 may be implemented as any suitable computing or electronic device, such as a user equipment device, a mobile communication device, a computing device, a client device, a mobile phone, a tablet computer, a laptop computer, a communication device, an entertainment device, a gaming device, a mobile gaming console, a personal media device, a media playback device, a charging station, an Advanced Driver Assistance System (ADAS), a point-of-sale (POS) transaction system, a health monitoring device, a drone, a camera, a wearable smart-device, a navigation device, a mobile-internet device (MID), an Internet home appliance capable of wireless Internet access and browsing, an Internet-of-Things (IoT) device, a Fifth Generation New Radio user equipment, and/or other types of user devices.

The wireless access point 160 may represent or be implemented as another device, radio access node, wireless communication node, or other suitable piece of equipment that facilitates wireless communication (via a wireless link) between a user equipment device and a communication network, such as a Local Access Network (LAN) router, a Wireless Local Access Network (WLAN) router, a wireless access point (WAP) in a managed (infrastructure) wireless network, a WiMAX subscriber station, a WiMAX gateway device, a Wi-Fi Direct device, a satellite, a terrestrial television broadcast tower, an access point, a peer-to-peer device, a user equipment device, another smart phone acting as a base station, a user equipment device acting as a base station, a wireless ad hoc network node, and so forth.

Method 600 is a method performed by a UE device 110. The method 600 is for selecting a wireless local area network 170 (WLAN 170) of a wireless access point 160 to connect to. At 602, at least one processor of the UE device 110 receives a network suggestion from a network-suggesting entity. The network suggestion requests connection of the UE device 110 to WLAN 170. In some cases, the network-suggesting entity is an application 220 on the UE device 110 or an internal implementation 222 of the UE device 110. Before 602, the UE device 110 may store connection performance data relating to one or more previous network connections with the WLAN 170 and the UE device 110 stores suggestor performance data relating to one or more previous wireless network suggestions received by the UE device 110 from the network-suggesting entity.

At 604, the UE device 110 reviews the connection performance data relating to one or more previous network connections with the WLAN 170. At 606, the UE device reviews the suggestor performance data relating to one or more previous wireless network suggestions received from the network-suggesting entity.

At 608, the UE device 110 determines, based on its review of the connection performance data and the suggestor performance data, that the connection performance data and/or the suggestor performance data satisfies a criterion. In some cases, the connection performance data may include received signal strength indicator (RSSI) signals and the criterion may be a RSSI threshold (e.g., an average RSSI) detected by the UE device 110. In some cases, the connection performance data may include data-rate information and the criterion may be a data-rate threshold of a signal that is detected by the UE device 110. In some cases, the suggestor performance data may be information regarding a frequency of successful previous connection to the wireless network and/or information regarding previous use of suggested wireless networks after successful connection, and the criterion may be a threshold of successful connections and/or a threshold of use of successful connections by the network-suggesting entity.

At 610, in response to determining that the connection performance data and/or the suggestor performance data satisfies the criterion, the UE device 110 establishes a wireless connection with the WLAN 170.

Method 700 is a method performed by a UE device 110. The method is for the UE device 110 to select a wireless local area network 170 (WLAN 170) of an access point 162 to connect to. At 702, the UE device 110 stores connection performance data relating to one or more previous network connections with the WLAN 170. At 704, the UE device 110 stores suggestor performance data relating to one or more previous wireless network suggestions received by the UE device 110 from the network-suggesting entity.

At 706, the UE device 110 receives a network suggestion from a network-suggesting entity requests connection of the UE device to the wireless local area network 165. The network-suggesting entity may be an application 220 on the UE device 110 or an internal implementation 222 of the UE device 110.

At 708, the UE device 110 reviews the connection performance data relating to one or more previous network connections with the WLAN 170. At 710, the UE device 110 reviews suggestor performance data relating to one or more previous wireless network suggestions received from the network-suggesting entity. At 712, the UE device 110 determines, based on reviewing the connection performance data and the suggestor performance data, that the connection performance data and/or the suggestor performance data satisfies a criterion. In some cases, the connection performance data may include received signal strength indicator (RSSI) signals and the criterion may be a RSSI threshold (e.g., an average RSSI) detected by the UE device 110. In some cases, the connection performance data may include data-rate information and the criterion is a data-rate threshold of a signal that is detected by the UE device 110. In some cases, the suggestor performance data may include information regarding a frequency of successful previous connection to the wireless network and/or information regarding previous use of the wireless network after successful connection, and the criterion may be a threshold of successful connections and/or a threshold of use of successful connections by the network-suggesting entity.

At 714, in response to determining that the connection performance data and/or the suggestor performance data satisfies the criterion, the UE device 110 device establishes a wireless connection with the WLAN 170.

### Variations

Although the above described systems and methods are described in the context of a UE device selecting a wireless network connection to connect to among multiple wireless connection options available for connection to, the described systems and methods are non-limiting and may apply to other contexts or wireless-communication environments.

Generally, any of the components, modules, methods, and operations described herein can be implemented using software, firmware, hardware (e.g., fixed logic circuitry), manual processing, or any combination thereof some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, Field-Programmable Gate Arrays (FPGAs), Application-Specific Integrated Circuits (ASICs), Application-Specific Standard Products (ASSPs), System-on-a-Chip systems (SoCs), Complex Programmable Logic Devices (CPLDs), co-processors, context hubs, motion co-processors, sensor co-processors, and the like.

Although aspects of a UE device selecting a wireless network connection have been described in language specific to features and/or methods, the subject of the appended claims is not necessarily limited to the specific features or methods described. Rather, the specific features and methods are disclosed as example implementations of a UE device selecting a wireless network connection and other equivalent features and methods are intended to be within the scope of the appended claims. Further, various different aspects are described, and it is to be appreciated that each described aspect can be implemented independently or in connection with other described aspects.

1. A method performed by a user equipment, the method comprising:
receiving, from a network-suggesting entity, a wireless network suggestion requesting connection of the user equipment to a wireless local area network (WLAN);
reviewing data, comprising at least one or more of:
reviewing connection performance data relating to previous network connections with the WLAN, or
reviewing suggestor performance data relating to previous wireless network suggestions received from the network-suggesting entity;
determining, based on the reviewed data, that the reviewed data satisfies a criterion; and
after determining that the reviewed data satisfies a criterion, establishing a wireless connection with the WLAN.

2. (canceled)

3. The method of claim 1,
wherein reviewing the connection performance data comprises:
reviewing at least one or more of received signal strength indicator (RSSI) signals, data-rate information, latency information, and end-to-end throughput; and
wherein determining that the reviewed data satisfies the criterion comprises at least one or more of:
determining that the reviewed data satisfies an average RSSI threshold,
determining that the reviewed data satisfies a data-rate threshold,
determining that the reviewed data satisfies a latency threshold, or
determining that the reviewed data satisfies an end-to-end throughput threshold.

4. The method of claim 1, wherein determining that the reviewed data satisfies the criterion comprises:
determining whether RSSI signals from the WLAN are gradually varying.

5. The method of claim 1,
wherein the suggestor performance data comprises at least one or more of:
information regarding a frequency of successful previous connections to the WLAN, or
information regarding previous use of the WLAN after successful connection; and
wherein the criterion comprises at least one or more of:
a threshold of successful connections, or
a threshold of use of successful connections by the network-suggesting entity.

6. The method of claim 1, further comprising at least one or more of:
before receiving the wireless network suggestion, storing the connection performance data; or
before receiving the wireless network suggestion, storing the suggestor performance data.

7. The method of claim 1, wherein the network-suggesting entity comprises an application on the user equipment or an internal implementation of the user equipment.

8. A method performed by a user equipment, the method comprising:
storing connection performance data relating to one or more previous network connections with a wireless local area network (WLAN);
storing suggestor performance data relating to one or more previous wireless network suggestions received by the user equipment;
receiving a current wireless network suggestion requesting connection of the user equipment to the WLAN;
reviewing the stored connection performance data relating to the one or more previous network connections with the WLAN;
reviewing the stored suggestor performance data relating to the previous wireless network suggestions received by the user equipment;
determining, based on reviewing the stored connection performance data and the stored suggestor performance data, that at least one or more of:
the stored connection performance data satisfies a criterion, or
the stored suggestor performance data satisfies a criterion; and
establishing, by the user equipment, a wireless connection with the WLAN.

9. The method of claim 8, further comprising at least one or more of:
storing the connection performance data relating to one or more previous network connections with the WLAN when a connection to the WLAN is active, or
storing the connection performance data relating to one or more previous network connections with the WLAN at disconnect.

10. The method of claim 8, further comprising:
populating a network report for the WLAN with previous connection performance data regarding the WLAN.

11. The method of claim 10, further comprising at least one or more of:
utilizing connection performance data stored in a network report to modify a list of preferred networks stored on the user equipment;
utilizing connection performance data stored in a network report to adjust a frequency for connectivity scans by the user equipment; or
utilizing connection performance data stored in a network report to adjust a timing for connectivity scans by the user equipment.

12. (canceled)

13. The method of claim 8, further comprising:
receiving user input from a user of the user equipment regarding the WLAN; and
considering the user input in determining, that at least one or more of:
the connection performance data satisfies a criterion, or
the suggestor performance data satisfies a criterion.

14. The method of claim 8, wherein an application running on the user equipment provides the current wireless network suggestion.

15. (canceled)

16. The method of claim 8, wherein:
the connection performance data comprises at least one or more of:
signal quality information at disconnect;
data-rate information at disconnect;
a disconnect parameter indicating by its parameter value one of several predefined reasons for disconnection from the WLAN;
a disconnect parameter indicating by its parameter value one of several predefined reasons for disconnection from the WLAN and whether the reason for disconnection was expected or unexpected;
basic service set identifier (BSSID) limits in size information;
connection duration information; or
wireless network connection information.

17. The method of claim 16, wherein the signal quality information at disconnect comprises a signal strength indicator (RSSI) signal.

18. The method of claim 8,
wherein the connection performance data comprises received signal strength indicator (RSSI) signals; and
wherein the criterion comprises an average RSSI threshold.

19. The method of claim 8,
wherein the connection performance data comprises at least one or more of data-rate information, latency information, or end-to-end throughput; and
wherein the criterion comprises at least one or more of a data-rate threshold of a signal detected by the user equipment, a latency threshold, or an end-to-end throughput threshold.

20. The method of claim 8,
wherein the suggestor performance data comprises at least one or more of information regarding a frequency of successful previous connection to the WLAN or information regarding previous use of the WLAN after successful connection.

21. The method of claim 20,
wherein the previous wireless network suggestions were received by the user equipment from a network-suggesting entity; and
wherein the criterion comprises at least one or more of:
a threshold of successful connections, or
a threshold of use of successful connections by the network-suggesting entity.

22. The method of claim 8, further comprising:
collecting, by the user equipment, additional connection performance data and suggestor performance data while the wireless connection is active; and
storing, by the user equipment, the additional connection performance data and suggestor performance data.

23-33. (canceled)

34. A method performed by a user equipment, the method comprising:
receiving, from a network-suggesting entity, a wireless network suggestion requesting connection of the user equipment to a wireless local area network (WLAN);
reviewing connection performance data relating to previous network connections with the WLAN, the reviewing the connection performance data comprising reviewing received signal strength indicator (RSSI) signals;
determining, based on the reviewed connection performance data, that the reviewed data satisfies a criterion, the determining that the reviewed data satisfies the criterion comprising determining whether RSSI signals from the WLAN are gradually varying; and
after determining that the reviewed data satisfies the criterion, deciding to not establish a wireless connection with the WLAN.
